(19) United States
(12) Patent Application Publication
(10) Pub. No.: US 2009/0224079 A1
(43) Pub. Date: Sep. 10, 2009

(54) Fuel injector, valve body remanufacturing process and machine component manufacturing method

(75) Inventors: Kirk Johnson, Rainbow City, AL (US); Shane Price, Weaver, AL (US); Evgeni Sychev, Laredo, AL (US); Francis E. Erbes, Laredo, TX (US); Howard D. Jenkel, Laredo, TX (US); James S. Millar, Chillicothe, IL (US)

Correspondence Address: CATERPILLAR c/o LIELL, MCNEIL & HARPER;Intellectual Property Department, AH9510, 100 N.E. Adams, Peoria, IL, 61629-9510, US

(73) Assignee: Caterpillar Inc.

(21) Appl. No.: 12/074,404

(22) Filed: Mar. 4, 2008

(51) Int. Cl. B05B 1/02

(52) U.S. Cl. 239/584

(57) ABSTRACT

A fuel injector includes an injector body having a plurality of body components, including an insert positioned within a second body component. The insert includes a conical valve seat and is attached to the second body component with a plurality of welds each including a stitch straddling a perimetric interface between the insert and the second body component. A remanufacturing process such as for a valve body of a fuel injector includes removing the damaged valve seat from within a salvaged valve body, and forming a substitute valve seat in an insert welded to the valve body with a plurality of crack free welds. Each of the welds includes a stitch straddling a perimetric interface between the insert and the valve body, and the insert may be formed of 52100 steel. Other machine components subjected to axial loading may be welded and otherwise processed in manufacturing or remanufacturing as described herein.

### TECHNICAL FIELD

The present disclosure relates generally to machine components and processes used in manufacturing and remanufacturing such components, and relates more particularly to a unique welding strategy for anchoring a first body component within a bore in a second body component.

### BACKGROUND

Over many years of machine system design and manufacturing, engineers have developed many ways to form, fashion and couple together system components. Press fitting, threads and welding are familiar examples of joining techniques commonly used. It has long been recognized that service environment, design, materials and other factors may render certain components best suited to one joining technique as compared to others. In the context of fuel injectors, components such as body components are often coupled together with threads. Other relatively small and specialized internal components of fuel injectors are commonly welded together. Laser welding, or other types of welding such as electron beam welding have been used for some time to weld together certain fuel injector components. Certain hard materials which might advantageously be used in manufacturing and remanufacturing fuel injectors, however, are well known to be challenging to weld due to their inherent properties. Limitations in the ability of engineers to weld certain materials has hindered development of improved and more broadly applicable manufacturing and remanufacturing technologies.

U.S. Pat. No. 6,441,335 to Nagaoka is directed to one process for welding members different in hardness. In particular, Nagaoka describes welding joint surfaces of a high-hardness number and a low-hardness number to one another by use of a laser or electron beam. Irradiation of the beam is offset from the joint surfaces of the two members by a predetermined distance. This is stated to allow melting provided by the beam to spread from the low-hardness to the high-hardness member. Nagaoka purports to improve weld quality despite the different hardness of the members to be joined. Nagoaka thus represents one example where a specific joining technique was developed based on inherent properties of the materials.

### SUMMARY

In one aspect, a fuel injector includes an injector body having a plurality of body components, one of the body components including an insert positioned at least partially within a bore defined by a second one of the body components. The insert includes a valve seat and an outer diameter abutting an inner diameter of the second one of the body components which defines the bore, at a perimetric interface. The fuel injector further includes a plurality of welds anchoring the insert within the bore, each of the welds including a stitch straddling the perimetric interface.

In another aspect, a method of manufacturing a component of a machine system includes, positioning a first body component to be subjected to axial loading in a machine system in a bore defined by a second body component and having a center axis. The method further includes anchoring the first body component in the bore at least in part by welding the first body component to the second body component. Positioning the first body component in the bore includes abutting an outer diameter of the first body component with an inner diameter of the second body component defining the bore, at a perimetric interface. Welding the first body component to the second body component includes forming a plurality of axial load reacting welds between the first body component and the second body component, each of the plurality of axial load reacting welds comprising a stitch straddling the perimetric interface.

In still another aspect, a valve body remanufacturing process includes removing a damaged valve seat from within a valve body, and positioning an insert including 52100 steel in place of the removed valve seat. The process further includes forming a substitute valve seat in the insert, and welding the insert to the valve body with a plurality of crack free welds, each of the welds including a stitch straddling a perimetric interface between the insert and the valve body.

### BRIEF DESCRIPTION OF THE DRAWINGS

FIG. 1 is a partially sectioned side diagrammatic view of a fuel injector according to one embodiment;

FIG. 2 is a sectioned side view of a component of the fuel injector of FIG. 1 at one stage of a remanufacturing process;

FIG. 3 is a sectioned side view of the component shown in FIG. 2 at another stage of a remanufacturing process;

FIG. 4 is a partial sectioned side view of the component shown in FIGS. 2-3 at yet another stage of a remanufacturing process;

FIG. 5 is a sectioned side view of a machine component according to one embodiment;

FIG. 6 is an elevational view of a machine component according to one embodiment;

FIG. 7 is a close-up view of a portion of the machine component shown in FIG. 6;

FIG. 8 is another close up view of a portion of the machine component shown in FIG. 6;

FIG. 9 is a sectioned side view through a portion of the machine component shown in FIG. 6; and

FIG. 10 is a pulse diagram for a laser welding process according to one embodiment.

### DETAILED DESCRIPTION

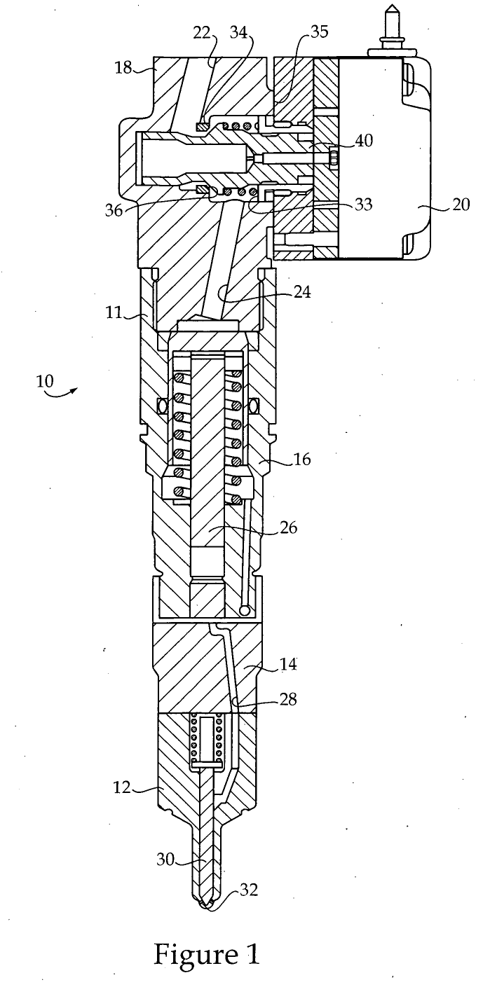

Referring to FIG. 1, there is shown a fuel injector 10 according to one embodiment. Fuel injector 10 may include an injector body 11 having a plurality of body components. In one example, injector 10 includes a first body component 12 such as a nozzle body having a needle check 30 positioned therein and configured to control fuel injection via a set of nozzle outlets 32. A nozzle supply passage 28 extends in body component 12, and into a second body component 14 coupled with body component 12. A third body component 16 may be coupled with body component 14 and has a piston or plunger 26 positioned therein which is configured to pressurize a fuel for supplying to nozzle supply passage 28. When the pressure of fuel in nozzle supply passage 28 is sufficient, needle check 30 will open to allow fuel to spray from nozzle outlets 32 into an engine cylinder (not shown) in a conventional manner.

Yet another body component 18 may be coupled with body component 16. A control valve member 40 is positioned at least partially in body component 18 and is movable to control fluid communications between a first fluid passage 22 and a second fluid passage 24. First fluid passage 22 may be configured to connect with a fuel supply or other fluid supply of an associated engine. Valve member 40 may move between a position blocking a first or upper seat 33 and a second position blocking a second or lower seat 36. When valve member 40 contacts lower seat 36, fluid communications past valve seat 36 and, hence, between passages 22 and 24 are blocked. When valve member 40 does not contact lower seat 36, fluid communications exist between passages 22 and 24. A timing face 35 may be formed on body component 18 to assist in timing the motion of valve member 40 in a manner known to those skilled in the art. An electrical actuator subassembly 20 may also be provided and coupled with valve member 40 to electrically actuate valve member 40. Subassembly 20 and valve member 40, along with various other components, may comprise a control valve assembly of fuel injector 10.

Fuel injector 10 may be of the type where fuel pressurization is achieved by way of piston 26 within injector body 11. In other words, an actuation fluid supplied via passage 22 may be selectively supplied to piston 26 to pressurize fuel by moving valve member 40 from its position blocking seat 36 to its position at which it does not block seat 36, in a conventional manner. In other embodiments, fuel injector 10 need not include any internal pressurization mechanism, and fuel might be supplied to injector 10 at an already sufficiently pressurized state from a common rail or the like. It should further be appreciated that fuel injector 10 represents one type of machine system and associated machine components which fall within the scope of the present disclosure, however, the present disclosure is not limited to fuel injectors, engines or even hydraulic systems, as will be apparent from the following description.

It is nevertheless contemplated that one practical application of the present disclosure will be in the field of remanufacturing or salvaging hydraulically actuated devices, such as fuel injectors. In the past it was common to scrap many of the components used in hydraulically actuated devices. In particular, valve bodies such as valve body 18 were often scrapped when a valve seat such as seat 36 reached a state of wear or damage where performance was affected. While various techniques for remanufacturing valve bodies have been proposed over the years, in the context of fuel injectors there have existed certain barriers to commercial success. The present disclosure addresses these issues as further described herein by providing strategies for remanufacturing valve bodies such as valve body 18, in an efficient and practicable manner which does not compromise future performance of the associated hydraulic device, such as fuel injector 10. In spite of the practical application to the field of remanufacturing, it should be appreciated that new machine components such as fuel injectors, or components using at least some new parts, might be manufactured in the manner described herein.

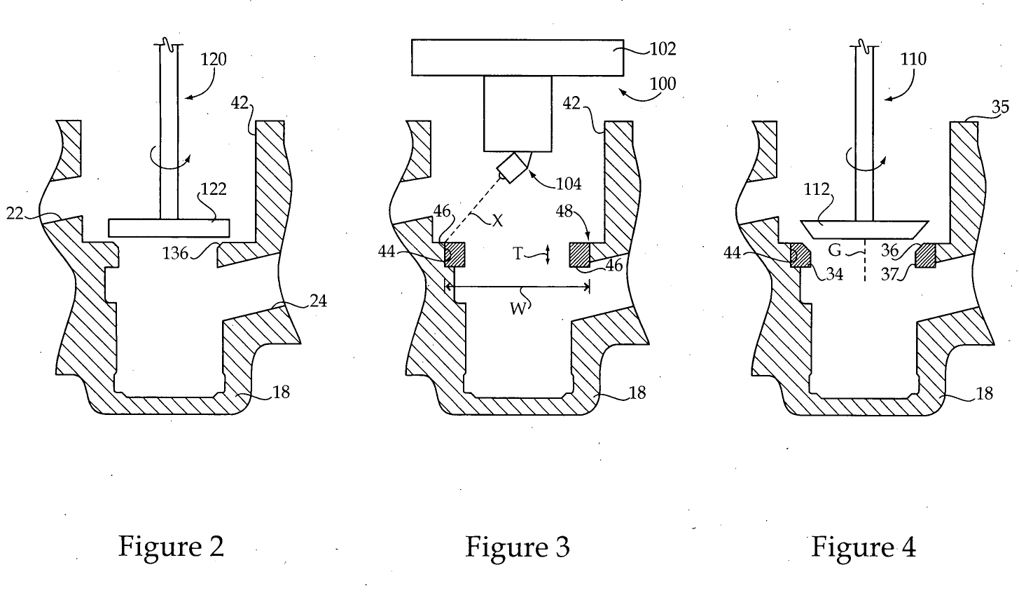

Valve seat 36 may comprise a conical valve seat formed in another body component 34 which comprises an insert 34 positioned in valve body 18. In one embodiment, insert 34 will comprise an annular ring and consist of a material having a hardness which is greater than a hardness of the material of which valve body 18 is made. In one further embodiment, insert 34 comprises 52100 steel or may consist essentially of 52100 steel. Where injector 10 comprises a remanufactured fuel injector, valve seat 36 may be a substitute valve seat in place of a valve seat originally formed in component 18. Referring also to FIG. 2, there is shown a valve body 18 similar to component 18 of injector 10 at one stage of a remanufacturing process according to the present disclosure. Fuel injector components may be expected to actuate millions, or even billions, of times over the course of a service life. In the case of valve body 18, the many impacts on its original valve seat with a valve member such as valve member 40, can lead to several problems. Erosion due to fluid flow, cavitation, and “beat-in” of the original valve seat may result from valve member impacts. When fuel injector 10 is received after removing from service in an engine, its existing valve seat may be worn or otherwise damaged to the point that the injector no longer functions as desired. It should be understood that the term “damaged” should be broadly construed as used herein. Valve seats exhibiting wear, deformation, pitting, cavitation, scratches or any other type of condition developed over time and potentially affecting performance could be considered damaged, as that term is intended to be understood.

Remanufacturing of a hydraulic machine component such as a fuel injector which includes valve body 18 may commence by disassembling valve body 18 from other components of fuel injector 10, after fuel injector 10 is removed from service in an engine system. The components may be cleaned, inspected for severe damage and the like, and then advanced for further processing. In one embodiment, material of valve body 18 which includes the original valve seat 136 may be removed from valve body 18 by machining a bore in valve body 18. In FIG. 2, a machining tool 120 having a rotating cutting or grinding element 122 may be used to machine damaged valve seat 136 from valve body 18 for this purpose.

Referring to FIG. 3, there is shown valve body 18 at one stage of a remanufacturing process after machining a new bore 44 in valve body 18, as depicted in FIG. 2. In one embodiment, new bore 44 is defined by an inner diameter of valve body 18 and may be formed so that it is coaxial with another bore 42 of valve body 18. Insert 34 may be press-fit in bore 44, having a perimetric interface 48 therewith, in place of the material removed when bore 44 is formed. In one embodiment, the press-fit between insert 34 and bore 44 may form a fluid seal or at least substantially form a fluid seal between insert 34 and bore 44. Flowable curable sealing material such as Loctite, or other materials might be used to create or ensure a fluid seal between insert 34 and bore 44. Insert 34 may have an outer diameter 46 which abuts bore 44 at perimetric interface 48. Outer diameter 46 defines a width W of insert 34, and may further comprise a thickness T perpendicular width W which is less than width W. Thickness T may be less than one-fifth width W. Once insert 34 is press-fit in bore 44, it may be anchored in bore 44 by forming a plurality of welds between insert 34 and valve body 18. Welds formed via a beam of coherent light, such as a laser, may be used. In FIG. 3, a laser welding apparatus 100 is shown having a base or housing 102 and a laser 104. Line X represents a beam path of a laser beam generated with laser 104 to weld insert 34 in place.

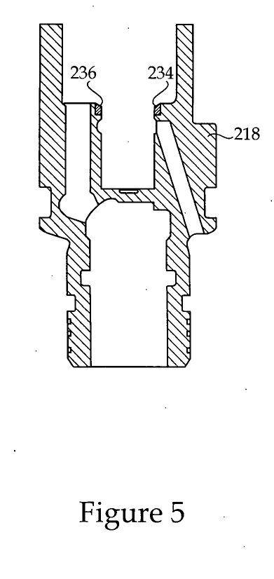

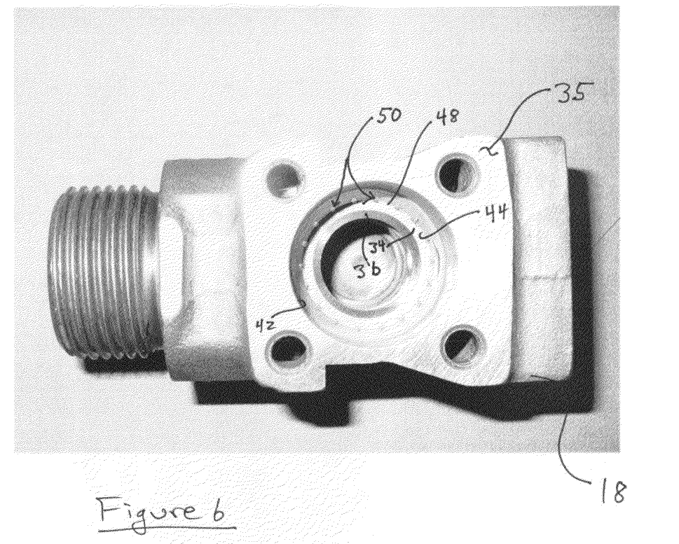

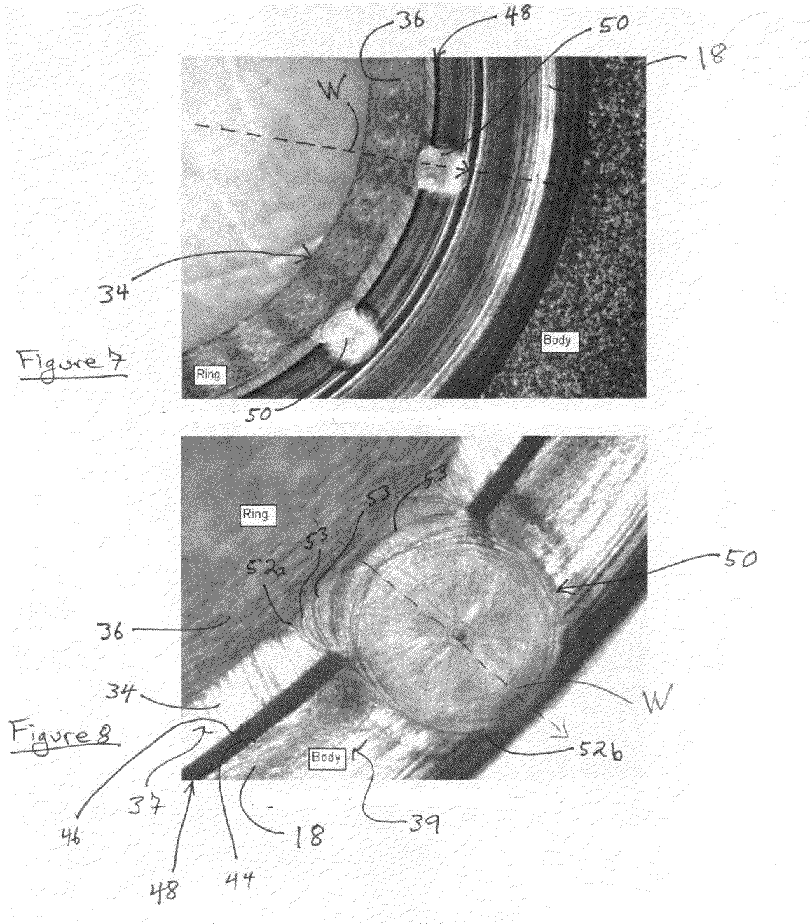

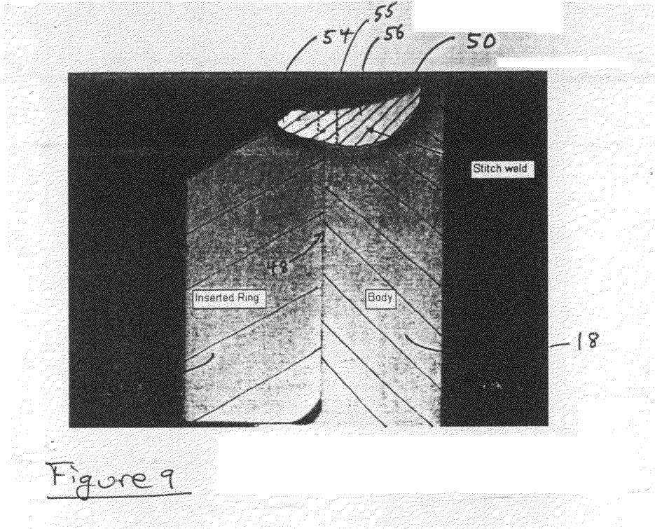

Turning now to FIG. 4, there is shown valve body 18 at another stage of a remanufacturing process after insert 34 has been welded to valve body 18. Another grinding or machining tool 110 having a rotatable grinding or machining element 112 may be used to machine a new seat 36 in insert 34. Timing face 35 is also shown in FIG. 4. Those skilled in the art will appreciate that a relative distance between timing face 35 and seat 36 may be a distance specified based on a desired timing of a valve member such as valve member 40. It has been discovered that properly locating seat 36 relative to timing face 35 may best be accomplished by forming seat 36 in insert 34 after press-fitting insert 34 with valve body 18, and after welding insert 34 to valve body 18. In other embodiments where valve timing precision is less of a concern, or where other means are used to locate seat 36 relative to timing face 35, seat 36 might be formed in insert 34 prior to press fitting insert 34 with valve body 18. In some instances, it may also be desirable for timing face 35 to be oriented relatively precisely in a plane perpendicular to an axis G of insert 34. Axis G may also be a center axis defined by bore 44. The desire for perpendicularity of time face 35 relative to axis G is due at least in part to an inner diameter 38 of insert 34 serving as a guide for valve member 40 during operation of fuel injector 10. Where timing face 35 is not perpendicular to axis G, problems relating to valve travel or timing may occur. To avoid these issues, one or both of timing face 35 and inner diameter 38 may be ground or reground during remanufacturing valve body 18 as described herein.

Referring also to FIG. 5, there is shown another valve body 218 remanufactured according to the present disclosure. Valve body 218 is similar to valve body 18 in that it includes an insert 234 positioned therein which has a valve seat 236 which comprises a substitute for a worn or damaged valve seat previously existing in valve body 218. Valve body 218 may be used in a fuel injector (not shown) which functions similarly to injector 10 described above, but is constructed differently such that a valve alternately blocking and opening valve seat 236 actuates in a travel direction aligned with a longitudinal axis of the fuel injector, instead of normal to a longitudinal axis of the fuel injector as is the case with fuel injector 10.

Once insert 34 has been welded into valve body 18, and seat 36 machined in insert 34, valve body 18 may be reassembled with other remanufactured or new fuel injector components and returned to service in an engine system.

Turning now to FIG. 6, there is shown valve body 18 in elevation, viewed approximately along a common center axis of bores 42 and 44. It will be recalled that welding insert 34 to valve body 18 may include anchoring insert 34 in bore 44 of valve body 18 with a plurality of welds 50. Each of welds 50 may comprise a stitch straddling perimetric interface 48. Welds 50 may be equally radially distributed about perimetric interface 48. In one embodiment, at least four welds 50 will be used and in other embodiments a larger number of welds such as at least eight welds may be used.

Referring also to FIG. 7, there is shown a close-up view of a portion of valve body 18, illustrating two of welds 50. Each of welds 50 may have a weld direction W which is transverse to perimetric interface 48, and in one embodiment may be perpendicular perimetric interface 48. Referring also to FIG. 8, there is shown an even closer view of a portion of valve body 18. It may be noted that the illustrated weld 50 or stitch includes a set of overlapping solidified weld pools, including a first weld pool 52a located at least predominantly in insert 34 and a last weld pool 52b located at least predominantly in valve body 18. Other weld pools may lie between pools 52a and 52b, represented approximately by each weld “ripple” 53 visible in FIG. 8. A length of each weld 50 may be about 0.080 inches in one embodiment. The set of weld pools which includes welds 52a and 52b will typically include at least three weld pools and defines weld direction W. In the embodiment shown, the set of weld pools are formed in essentially a straight line, and result from the path traversed by laser 104 during welding insert 34 to valve body 18 as further described herein.

It may be noted from the FIG. 8 illustration that insert 34 includes a first land area 37 having an edge which comprises outer diameter 46 of insert 34 located at perimetric interface 48. Valve body 18 may include a second land area 39 having an edge comprising the portion of the inner diameter of valve body 18 which defines bore 44. The edges 44 and 46 of land areas 39 and 37, respectively, are aligned at perimetric interface 48. It may further be noted that the illustrated weld 50 extends from a position within land area 37 to another position within land area 39.

Turning to FIG. 9, there is shown a cross section through a portion of valve body 18 and insert 34, as well as through a weld 50. Weld 50 includes a first weld portion 54 within insert 34, a second weld portion 55 which is within each of insert 34 and valve body 18 and straddles perimetric interface 48, and a third weld portion 56 which is within valve body 18. In one embodiment, first weld portion 54 may consist of melted then solidified material of insert 34, third weld portion 56 may consist of melted then solidified material of valve body 18, and second weld portion 55 may consist of a mixture of melted then solidified material of insert 34 and valve body 18.

### INDUSTRIAL APPLICABILITY

The fields of remanufacturing and salvaging have expanded in recent years, yet viable strategies for restoring certain types of machine components to original specifications have been elusive. Valve bodies are one example of a class of machine components which it is known to salvage and return to service, but largely by strategies having various drawbacks. Valve seat regrinding in various forms has been known for many years, but changes in a distance between the reground valve seat and a timing face for the associated valve member tend to occur from regrinding and may be difficult to remedy. The timing face itself may be reground to return the distance to the valve seat to a specified distance, however, regrinding of the timing face can shorten the valve body, particularly causing problems where the valve seat and timing face are reground multiple times. Eventually, regrinding may also expose un-hardened material not suitable as a valve seat. It may also be difficult to locate machine tools during regrinding a valve seat precisely enough to maintain the valve seat location relative to other features within specified tolerances. Further still, in some instances valve seat damage, wear, etc., may be severe enough that regrinding cannot cure the defects without altering the valve body to the point that operation is compromised. Where applied in the context of remanufacturing, the present disclosure overcomes the problems and shortcomings associated with many earlier strategies for valve seat repair or refurbishing. In many instances it will be unnecessary to regrind a valve timing face of a valve body, as a valve seat newly formed in an insert can be located at a specified distance from the valve timing face. Since inserts contemplated herein may be formed from 52100 steel, the valve seat in the insert will tend to be relatively highly resistant to wear and damage. Should a valve body remanufactured as described herein be removed from service for another round of remanufacturing, its valve seat may be reground to give the valve body yet another service life, without exposing soft material.

Another feature of the present disclosure applicable in remanufacturing valve bodies, particularly those of hydraulically actuated control valves for fuel injectors, is the welding strategy disclosed herein. When a valve member, such as poppet valve member 40 shown in FIG. 1 actuates, it tends to subject valve seat 36 to relatively high axial loading. Over the course of a service life, valve member 40 may hit valve seat 36 many times, as described herein, with relatively high axial force. A desire to use relatively hard materials for insert 34, and the need to react relatively high, repetitive axial loads on insert 34, is answered by the presently described welding strategy.

Conventional wisdom in the welding arts has for many years been that successful welding of 52100 steel and certain other materials is nearly or totally impossible. Even where some degree of fusion between a component formed from 52100 steel and another component is achieved, cracks tend to form almost immediately after welding ceases. Development of cracks has prevented engineers from welding 52100 steel in most, if not all industrial applications. Returning to FIGS. 7, 8 and 9, it may be noted that each weld 50 is crack free. Formation of welds 50 without cracks is believed to result at least in part from the manner in which laser 104 is operated during welding insert 34 to valve body 18.

In one embodiment, each weld 50 will be initiated by first applying a beam from laser 104 to insert 34. In general, laser 104 may form first weld pool 52a which is at least predominantly and typically entirely in insert 34, and then form a string of successive overlapping weld pools which progress to last weld pool 52b, at least predominantly and typically entirely in valve body 18. It will be recalled that insert 34 may consist essentially of 52100 steel in one embodiment, and may be relatively homogeneous. Thus, formation of first weld pool 52a may result from melting of the relatively homogeneous 52100 steel. As welding of a particular weld 50 progresses, material comprising the weld pools as welding approaches and then traverses perimetric interface 48 may gradually begin to include material of valve body 18. When welding has passed across perimetric interface 48 material comprising the weld pools may eventually consist entirely of material of valve body 18.

It is believed that initiating welding in first weld portion 54, relatively homogeneous material of insert 34, then relatively gradually moving into second weld portion 55, mixed material of both insert 34 and valve body 18, and then completing welding in third weld portion 56, relatively homogeneous material of valve body 18, allows a more gradual heating up and cooling down of the material which eventually solidifies to form each weld 50. This differs from earlier welding strategies along a cylindrical perimetric interface where heating and/or cooling of the materials to be joined was relatively more rapid. Circumferential stitch welds, in contrast to the radial stitch welds 50 described herein, would be one such example. It is further believed that the relatively gradual temperature changes in the second weld portion 55 comprising a mixture of material of insert 34 and material of valve body 18 inhibits the formation of cracks upon cooling, as the material appears to experience relatively less thermal stress associated with welding.

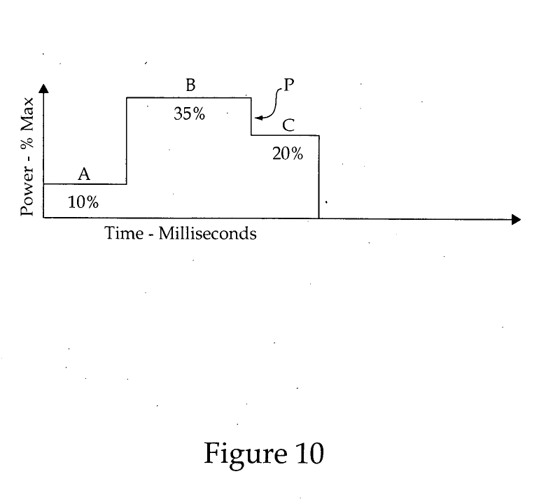

Laser 104 may comprise a Lumonics JK 701H YAG Laser having a max power of 500 Watts in one embodiment, capable of pulsed operation to form the sets of weld pools comprising each weld 50, as described herein. The spot size of laser 104 may be about 0.5 millimeters in one embodiment, pulse duration may be about 20 milliseconds and frequency may be about 10 Hz. Laser speed may be about 1.96 millimeters per second. In other embodiments, differing laser parameters may be used. Turning now to FIG. 10, there is shown a laser pulse diagram illustrating one exemplary power curve for laser 104 according to the present disclosure and representing one pulse P. It will be recalled that laser 104 may have a maximum power output of about 500 Watts. Pulse P may include a plurality of pulse segments, including a first segment A having a duration of about 6 milliseconds at about 10% of max power, a second segment B having a duration of about 9 milliseconds at about 35% of max power and a third segment C having a duration of about 5 milliseconds at about 20% of max power. Each of the pulses used in forming each weld 50 may have the same power profile as that shown in FIG. 10.

The present description is for illustrative purposes only, and should not be construed to narrow the breadth of the present disclosure in any way. Thus, those skilled in the art will appreciate that various modifications might be made to the presently disclosed embodiments without departing from the full and fair scope of the present disclosure. For example, while much of the foregoing description emphasizes the context of fuel injectors, and in particular remanufacturing fuel injectors, the present disclosure is not thereby limited. Other machine systems such as engine systems other than fuel systems, and even technologies unrelated to engines may have body components which are subjected to axial loading, and thus need to be securely anchored in a second body component, such as in a bore.

Welding and potentially press fitting of one body component of a machine system within a second body component of a machine system, as described herein, can provide a means for reacting axial loads to provide a robust anchoring strategy for machine components in a wide variety of technologies. Welds 50 may thus comprise axial load reacting welds of a type suitable for use in a broad variety of applications. One example outside the context of fuel systems would be in the field of actuators where mechanical stops of relatively hard material are often used to react axial loads on actuators rods and the like. Such stops can wear over time and need to be replaced. Inserting an insert as described herein into certain actuator bodies, and welding it therein, could provide a means for remanufacturing some systems which were previously scrapped. Other aspects, features and advantages will be apparent upon an examination of the attached drawings and appended claims.

What is claimed is:

1. A fuel injector comprising:
an injector body having a plurality of body components, one of said body components comprising an insert positioned at least partially within a bore defined by a second one of said body components;
said insert including a valve seat and an outer diameter abutting an inner diameter of the second one of said body components which defines the bore, at a perimetric interface; and
said fuel injector further comprising a plurality of welds anchoring said insert within the bore, each of said welds comprising a stitch straddling said perimetric interface.

2. The fuel injector of claim 1 wherein said insert comprises a first land area having a first edge at said perimetric interface and the second one of said body components comprises a second land area having a second edge aligned with said first edge at said perimetric interface, and wherein each said stitch defines a weld direction transverse to said perimetric interface and extends from a position within said first land area to another position within said second land area.

3. The fuel injector of claim 2 wherein the second one of said body components is formed from a first material having a first hardness, and wherein said insert is formed from a second material having a second hardness greater than said first hardness.

4. The fuel injector of claim 3 wherein said insert consists essentially of 52100 steel.

5. The fuel injector of claim 2 wherein each said stitch comprises a set of overlapping solidified weld pools, including a first weld pool located in said insert and a last weld pool located in the second one of said body components.

6. The fuel injector of claim 5 wherein said plurality of welds includes at least four welds, and wherein each of the sets of solidified weld pools includes at least three solidified weld pools defining a weld direction normal to said perimetric interface.

7. The fuel injector of claim 1 wherein said insert comprises a ring having an outer diameter defining a width and a thickness perpendicular said width which is less than said width, and wherein the bore defined by the second one of said body components is fluidly sealed with the outer diameter of said insert via a press fit.

8. The fuel injector of claim 7 wherein said seat is a conical valve seat, said fuel injector further comprising a second valve seat, and an electrically actuated control valve movable between a first position at which it blocks said conical valve seat and a second position at which it blocks said second valve seat.

9. A method of manufacturing a component of a machine system comprising:
positioning a first body component to be subjected to axial loading in the machine system in a bore defined by a second body component and having a center axis;
anchoring the first body component in the bore at least in part by welding the first body component to the second body component;
wherein positioning the first body component in the bore includes abutting an outer diameter of the first body component with an inner diameter of the second body component defining the bore, at a perimetric interface; and
wherein welding the first body component to the second body component includes forming a plurality of axial load reacting welds between the first body component and the second body component, each of the plurality of axial load reacting welds comprising a stitch straddling the perimetric interface.

10. The method of claim 9 wherein the second body component comprises a valve body of a fuel injector and the first body component comprises an annular insert, and wherein positioning the first body component in the bore further comprises press fitting the insert into the bore.

11. The method of claim 10 comprising remanufacturing the valve body of the fuel injector, the method further comprising removing a damaged valve seat from within the valve body at least in part by machining the bore in the valve body, and forming a substitute valve seat in the first body component subsequent to welding the first body to the second body component.

12. The method of claim 11 wherein welding the first body component to the second body component comprises forming each of the welds by applying a beam of coherent light to the first body component, then applying a beam of coherent light to the second body component.

13. The method of claim 10 wherein forming each one of the axial load reacting welds comprises forming a plurality of sets of overlapping weld pools, each of the sets of overlapping weld pools defining a weld direction transverse to the perimetric interface and including a first weld pool located at least predominantly in the first body component and a last weld pool located at least predominantly in the second body component.

14. The method of claim 13 wherein the first body component consists essentially of 52100 steel having a hardness and the second body component comprises another material having a second, lesser hardness, and wherein welding the first body component to the second body component further comprises forming at least four welds spaced radially about the perimetric interface.

15. A valve body remanufacturing process comprising:
removing a damaged valve seat from within a salvaged valve body;
positioning an insert comprising 52100 steel in place of the removed valve seat;
forming a substitute valve seat in the insert; and
welding the insert to the valve body with a plurality of crack free welds, each of the welds comprising a stitch straddling a perimetric interface between the insert and the valve body.

16. The process of claim 15 wherein forming a substitute valve seat in the insert comprises forming a conical valve seat in the insert after welding the insert to the valve body.

17. The process of claim 16 wherein the valve body comprises a valve body of a fuel injector, the process further comprising:
receiving a fuel injector after service in an engine; and
disassembling the valve body from the fuel injector prior to removing the damaged valve seat;
wherein removing the damaged valve seat further comprises machining a bore in the valve body, and wherein forming a fluid seal further comprises press fitting the insert in the bore.

18. The process of claim 17 wherein welding the insert to the valve body further comprises welding via a beam of coherent light at least four welds evenly radially distributed about the perimetric interface, and wherein each of the welds defines a weld direction perpendicular to the perimetric interface and extends from a first position within a first land area of the insert to a second position within a second land area of the valve body.
